(19) United States
(12) Patent Application Publication
(10) Pub. No.: US 2005/0060315 A1
(43) Pub. Date: Mar. 17, 2005

(54) Metadata database lookup system

(76) Inventor: Aleksey Sanin, Sunnyvale, CA (US)

Correspondence Address: GLENN PATENT GROUP, 3475 Edison Way, Suite L, Menlo Park, CA, 94025, US

(21) Appl. No.: 10/666,883

(22) Filed: Sep. 16, 2003

(51) Int. Cl. G06F 7/00

(52) U.S. Cl. 707/9

(57) ABSTRACT

A metadata database lookup system provides a database is that contains a cross-reference of metadata information to a service provider ID number or universal resource identifier (URI). A service provider ID number is keyed to metadata information about a specific resource from a service provider. The metadata information can contain a description of the resource, the universal resource locator (URL) for the resource, and any other pertinent information that may be associated with the resource. The invention uses a constant ID number for a service provider and its resource. A resource requestor uses the ID number for the desired service provider resource. The ID number is cross referenced with the proper metadata information for the resource and the resource requestor uses the metadata information as needed and accesses the resource using the URL in the metadata. The resource requester is unaffected by updates to a resource's description or address by the service provider. The database tracks the metadata and URIs for resources for a specific service provider or resources for multiple service providers.

### BACKGROUND OF THE INVENTION

1. Technical Field

The invention relates to network resource addressing and access. More particularly, the invention relates to the mapping of network resources using resource ID to universal resource locator address mapping.

2. Description of the Prior Art

Distributed computing systems began with dumb terminals and teletypes connected to a central computer. Any resources that the central computer offered were directly connected or contained in the central computer itself. As computing systems expanded to networked systems, the number of servers that could be accessed by users increased to whatever servers that could be addressed within the local network itself.

The Internet resulted in a massively distributed system where many servers and clients transferred data among themselves. Service providers now commonly provide resource access to users across intranet and Internet systems. To access a resource, a user must have knowledge of the service provider's location address and the resources that are provided by the service provider.

Uniform Resource Identifiers (URI) and Universal Resource Locators (URL) are short strings that identify resources in the Internet (or Web). Examples of resources are: documents, images, downloadable files, services, electronic mailboxes, etc. The URIs and URLs make resources available under a variety of naming schemes and access methods such as HTTP, FTP, and Internet mail uniformly addressable.

A user accesses the desired resource using the URI of the resource. The drawback to this approach is that the user must have knowledge of the particular resource and the URL address of the service provider.

It would be advantageous to provide a metadata database lookup system that provides a requesting system with an identifier for a service provider that is used to reference a URL address for a resource provided by the service provider. It would further be advantageous to provide a metadata database lookup system that provides a database reference method that can be implemented in a centralized enterprise system as well as an Internet configuration.

### SUMMARY OF THE INVENTION

The invention provides a metadata database lookup system. The invention provides a requester with an identifier for a service provider that is used to reference a URL address for a resource provided by the service provider. In addition, the invention provides a database reference method that is easily implemented in a centralized enterprise system as well as an Internet configuration.

A preferred embodiment of the invention provides a database is that contains a cross-reference of metadata information to a service provider ID number or universal resource identifier (URI). A service provider ID number is keyed to information about a specific resource from a service provider. The metadata information can contain a description of the resource, the universal resource locator (URL) for the resource, and any other pertinent information that may be associated with the resource. The invention uses a constant ID number for a service provider and its resource.

A resource requester uses the ID number for requesting metadata information for the desired service provider resource. The ID number is cross referenced with the proper information for the resource and the resource is then addressed by the resource requestor using the URL. The resource requestor uses the metadata information as needed and accesses the resource using the URL in the metadata information. The resource requester is unaffected by updates to a resource's description or address by the service provider.

In an embodiment of the invention, the database is stored on a central storage server. The database contains resource metadata information for all of the service providers within the central storage server's responsibility. The central storage server's responsibility can be locality, assignment, or trust based. When a resource requester needs to access a resource, the resource requestor sends a metadata information request with the service provider's ID to the central storage server.

The central storage server verifies the request, references its database using the service provider's ID, and retrieves the service provider's resource information from the database. The central storage server sends the resource information to the resource requestor.

The resource requestor uses the resource metadata information to, for example, display the resource description to a user. When the resource requestor needs to access the resource, it uses the URL obtained from the resource metadata information to access the resource from the service provider. The service provider resource returns the appropriate data to the resource requestor.

In another embodiment of the invention, the database resides locally on a service provider's site. The database contains resource information for the service provider's resources. When a resource requestor needs to access one of the service provider's resources, the resource requestor sends a metadata information request with the service provider's ID to the service provider.

The service provider receives the information request from the resource requestor and references its local database using the ID. The ID is cross referenced to the information for the service provider's resource. The resource information is then sent from the service provider to the resource requester.

The resource requestor uses the resource information to, for example, display the resource description to a user. When the resource requestor needs to access the resource, it uses the URL obtained from the resource information to access the resource from the service provider. The service provider's resource returns the appropriate data to the resource requestor.

Other aspects and advantages of the invention will become apparent from the following detailed description in combination with the accompanying drawings, illustrating, by way of example, the principles of the invention.

### BRIEF DESCRIPTION OF THE DRAWINGS

FIG. 1 is a block schematic diagram of a network view of the invention according to the invention;

FIG. 2 is a diagram of an exemplary database entry showing cross referencing of a URI to a resource URL according to the invention;

FIG. 3 is a block schematic diagram illustrating a centralized approach of the invention where a resource database is located in a centralized server according to the invention;

FIG. 4 is a block schematic diagram illustrating a localized approach of the invention where resource databases are located at a service provider's site according to the invention; and

FIG. 5 is a block schematic diagram of an task viewpoint of the invention according to the invention.

### DETAILED DESCRIPTION OF THE INVENTION

The invention is embodied in a metadata database lookup system. A system according to the invention provides a requester with an identifier for a service provider that is used to reference a URL address for a resource provided by the service provider. The invention additionally provides a database reference method that is easily implemented in a centralized enterprise system as well as an Internet configuration.

Resources such as documents, images, downloadable files, services, electronic mailboxes, etc., are typically provided across networks by individual companies to other companies and users. These resources must somehow be maintained by the providing company, or service provider, during the normal course of business. For example, the maintenance of resources can include relocating the resource to another address where the address is a universal resource locator (URL) because a server was overloaded, updating a text description of a resource due to an expansion or contraction of services, etc.

A drawback to updates is that other service providers and users (resource requestors) may not be aware of the updates and somehow must be notified. Without any notification, resource requestors will encounter errors such as broken links or unexpected results from the resource. The service provider must somehow update information about its resource across multiple locations across the attached network whenever a change is effected. This becomes a large problem that makes it difficult for the service provider to maintain its resources.

The invention provides a simpler, more efficient approach that allows a resource requestor to use an ID that does not change to access a resource. Using an ID allows the resource requestor to quickly access the resource. The ID is resolved by a central server or service provider to the resource's actual address and description and provided to the resource requester. The resource requestor then uses the address to access the resource.

The invention allows service providers to change information regarding their resources by updating resource information at a location that is under their control. The invention makes it much easier and convenient for service providers to maintain their resources.

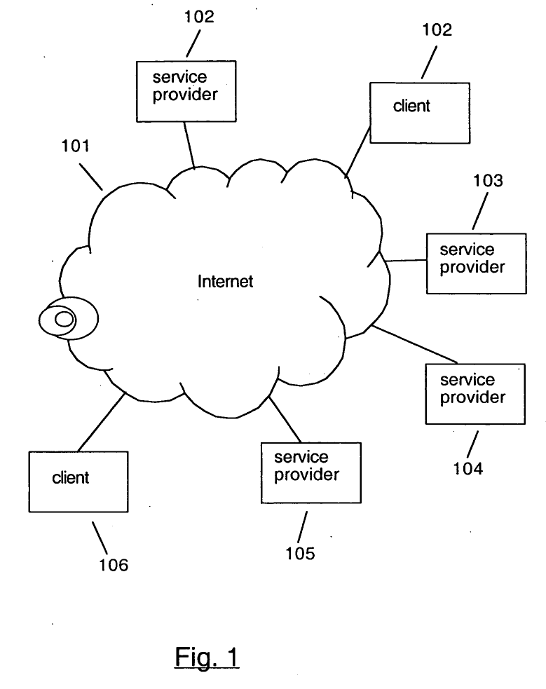

Referring to FIG. 1, service providers 102, 103, 104, 105 provide resources across a network 101, such as the Internet. The resources are available to clients 102, 106 and other service providers 102,103,104,105. Traditional systems require that the clients 102, 106 and other service providers 102, 103, 104, 105 know the specific Universal Resource Locator (URL) of the service provider's resource to access the resource.

A preferred embodiment of the invention allows clients 102, 106 and other service providers 102, 103, 104, 105 to use a service provider's ID number to obtain an address to a service provider's resource. The service provider's ID number can be a Uniform Resource Identifier (URI) or a predetermined numerical ID. The ID number is keyed to a specific resource for the service provider. A database is provided that cross references ID numbers with resource URLs. The invention assures that the service provider does not have to update multiple locations whenever a resource description or location is changed.

Typically, resource requesters had to update their links to service provider's resources whenever a resource changed at the service provider's site. This caused dead links and other access problems. The invention solves these problems by using a constant ID number for the service provider and its resource. A resource requestor uses the ID number for the desired service provider resource. The ID number is cross referenced with the proper URL for the resource and the resource is then addressed by the resource requester using the URL. The resource requester is unaffected whenever a service provider updates a resource's description or address.

In another preferred embodiment of the invention, the service provider ID number is keyed to a location in the database that contains metadata relating to the service provider's resource. The metadata can contain a description of the resource, the URL for the resource, and any other pertinent information that may be associated with the resource. When the resource requester sends a request to the ID number, the metadata for the particular resource is returned to the resource requestor. The resource requestor uses the metadata as needed and accesses the resource using the URL in the metadata.

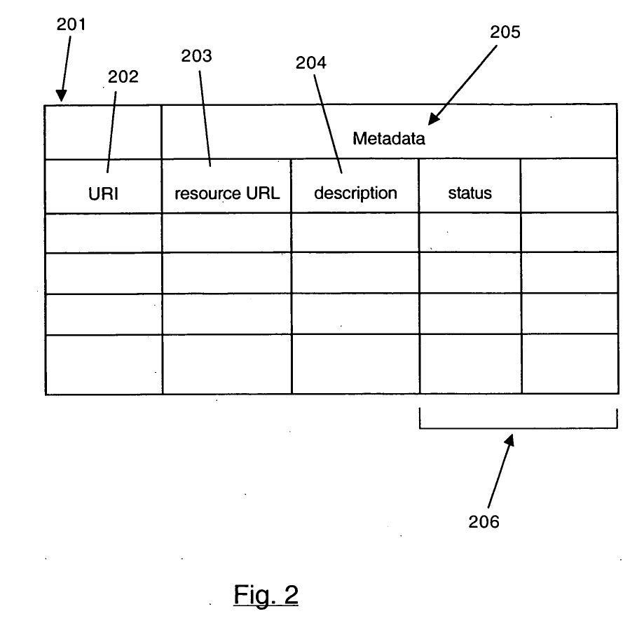

With respect to FIG. 2, a database 201 is provided that contains a cross-reference of metadata information 205 to a URI 202. A URI 202 is keyed to information about a specific resource from a service provider. Depending on the application (as described below), the database tracks the metadata and URIs for resources for a specific service provider or resources for multiple service providers.

Metadata 205 are composed of data concerning a resource. For example, a resource URL 203 tells the resource requestor the address where the resource is located, a description of the resource 204 is included as well as other pertinent information 206.

The database can be located in a central server in an enterprise situation or distributed within service providers. The invention changes the URI to a URL. The URL is now both the URI and the resource locator.

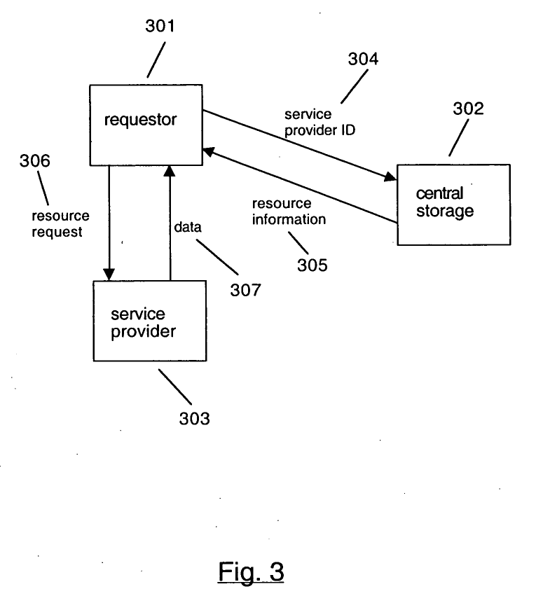

Referring to FIG. 3, a centralized approach of a preferred embodiment of the invention is shown where the database is stored on a central storage server 302. The database contains resource information for all of the service providers within the central storage server's responsibility. The central storage server's area of responsibility can be locality, assignment, or trust based. When a resource requestor 301 needs to access a resource, the resource requestor 301 sends a metadata information request with the service provider's ID 304 to the central storage server 302.

The central storage server 302 verifies the request and references its cross reference database using the service provider's ID (URI in this case). The URI key is found in the database and the service provider's resource information is retrieved from the database. The resource information is sent from the central storage server 302 to the resource requester 301.

The resource requestor 301 uses the resource information to, for example, display the resource description to a user. When the resource requestor 301 needs to access the resource, it uses the URL from the resource information to access the resource from the service provider 303. The URL addresses the service provider 303 resource. The service provider 303 resource returns the appropriate data 307 to the resource requestor 301.

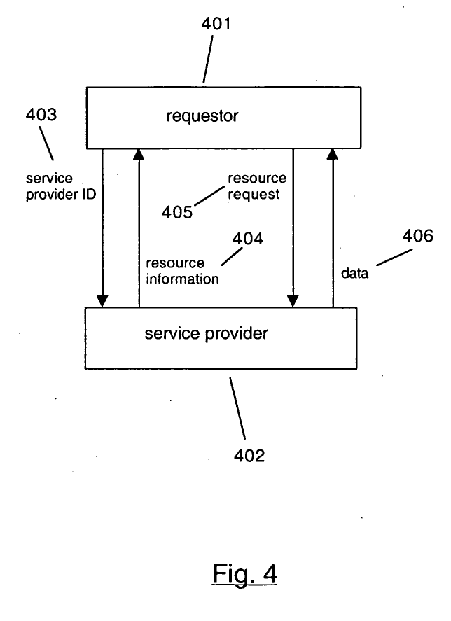

With respect to FIG. 4, a distributed network approach of a preferred embodiment of the invention is shown where the database resides locally on the service provider 402 site. The database contains resource information for the service provider's resources. When a resource requestor 401 needs to access one of the service provider's resources, the resource requestor 401 sends a metadata information request with the service provider's ID 403 to the service provider 402.

The service provider 402 receives the information request from the resource requestor 401 and references its local database using the ID. The ID is cross referenced to the information for the service provider's resource. The service provider 402 retrieves the information for the requested resource from the cross referenced location. The resource information is then sent 404 from the service provider 402 to the resource requestor 401.

The resource requestor 401 uses the resource information to, for example, display the resource description to a user. When the resource requestor 401 needs to access the resource, it uses the URL from the resource information to access the resource 405 from the service provider 402. The URL addresses the service provider resource. The service provider's 402 resource returns the appropriate data 406 to the resource requestor 401.

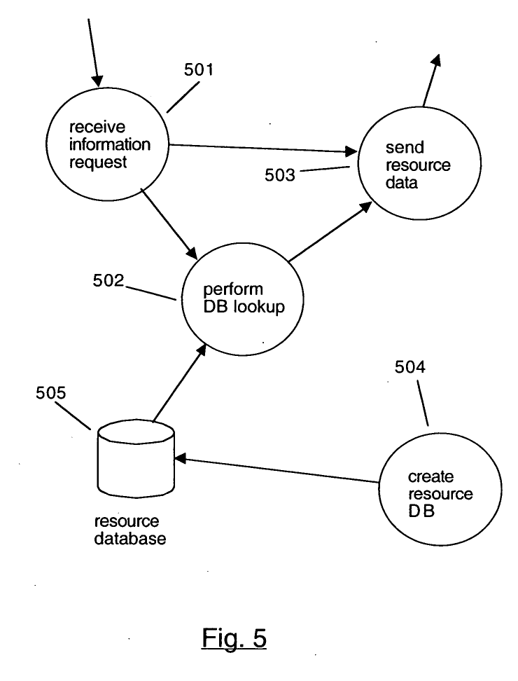

Referring to FIG. 5, a task viewpoint of the invention is shown. The resource database 505 is created by the create resource DB task 504. The create resource DB task 504 creates a resource database 505 that is dependent upon the application. If the resource database 505 is targeted for a central storage server, the create resource DB task 504 creates a resource database 505 that contains the resource information for all of the service provider resources in the central storage server's area of responsibility. This could cover multiple service providers and their resources.

For the case where a service provider hosts the resource database 505 locally on its site, the create resource DB task 504 creates a resource database 505 that contains the resource information for all of the service provider's resources.

During normal operation, a receive information request task 501 receives metadata information requests from resource requesters. The receive information request task 501 passes the service provider ID to the perform DB lookup task 502. The perform DB lookup task 502 looks into the resource database 505 and cross references the service provider ID to find the corresponding resource information. The perform DB lookup task 502 passes the resource information to the send resource data task 503.

The send resource data task 503 previously receives the resource requestor's address from the receive request task 501. Once the send resource data task 503 receives the resource information from the perform DB lookup task 502, it sends the resource information to the resource requestor's address.

The problem is that there is a resource and a resource ID and it is difficult to access to resource quickly using the ID. The user tries to get the resource by the name. In our case, the resource ID is a Universal Resource Identifier (URI). This happens over a network with different computers referencing the resource and needing to quickly get to the resource through the resource ID.

The following is an example of an application of the invention in a trusted environment where the resource requesters and service providers are trusted entities among themselves.

### TRUSTED ENVIRONMENT EXAMPLE

Centralized “metadata service”.

The centralized “metadata service” provides a metadata exchange service for all service providers inside a circle of trust. Any service provider may request metadata for another service provider from the metadata service or upload its own metadata information to the “metadata service”. The metadata service supports the <metadata:MetaDataGetRequest> request and may also support <metadata:MetaDataPostRequest> request.

To improve performance, the service provider may cache the metadata information retrieved from metadata service according to cache control directive in the response.

Distributed Metadata Storage.

Every service or identity provider has a URI based provider ID that uniquely identifies the provider in the network. In case of distributed metadata storage, the provider ID URI is interpreted as a URL that points to the provider's metadata (for example, a service provider's SOAP endpoint URL may be used as a provider's ID URI). When a service provider wants to get data for another provider it simply issues <metadata:MetaDataGetRequest> request to the provider ID URL and receives in a response, the provider's metadata in the <metadata:MetaDataGetResponse> response. In most cases, in response to the <metadata:MetaDataGetRequest> request, the service provider returns the same metadata information. However, the service provider may return different metadata information depending on the requestor's provider ID

To improve performance, the service provider may cache the metadata information retrieved from another service provider according to a cache control directive in the response.

Security

To prevent metadata “spoofing” the receiver of metadata information should verify its integrity and origin using XML Signature, SSL/TLS authentication or any other secure equivalent method. Most of the metadata information is not sensitive and by this does not require encryption. However, transport level encryption (SSL/TLS), message level encryption (XML Encryption) or any other secure equivalent method may be used to protect the metadata information. Also “metadata service” or service provider MAY restrict the metadata distribution (using the requestor's provider ID).

<MetaDataGetRequest> request

The service provider issues <metadata:MetaDataGetRequest> request to a metadata service or another service provider's provider ID URL in order to obtain the metadata information.

Schema Definition.

The elements of the request are as follows:
MajorVersion [Required]
   Major version of the request.
MinorVersion [Required]
   Minor version of the request.
ProviderID [Required]
   The requestor service provider's URI-based identifier.
SubjectProviderID [Required]
   The URI-based identifier that identifies service provider to retrieve metadata for.
IfModifiedSince [Optional]
   The time of the current metadata information available to the requester.
Signature [Optional]
   The request signature.

The schema fragment defining the element and its type is as follows:

```
<element name=“MetaDataGetRequest”
type=“metadata:GetRequestType”/>
  <complexType name=“GetRequestType”>
    <sequence>
      <element name=“ProviderID” type=“anyURI”/>
      <element name=“SubjectProviderID” type=“anyURI”/>
      <element name=“IfModifiedSince” type=“dateTime”
      minOccurs=“0”/>
      <element ref=“ds:Signature” minOccurs=“0”/>
    </sequence>
    <attribute name=“MajorVersion” type=“integer” use=“required”/>
    <attribute name=“MinorVersion” type=“integer” use=“required”/>
    </complexType>
```

### EXAMPLE

```
<MetaDataGetRequest MajorVersion=“1” MinorVersion=“0”>
  <ProviderID>http://ServiceProvider1.com/id</ProviderID>
  <SubjectProviderID>http://ServiceProvider2.com/id</
  SubjectProviderID>
  <IfModifiedSince>2002-12-17T09:30:47-05:00</IfModifiedSince>
  <ds:Signature>...</ds:Signature>
</MetaDataGetRequest>
```

Processing Rules

When a metadata service or service provider receives an <metadata:MetaDataGetRequest> request, it processes the request according to the following rules:
<ds:Signature>, if present, it is the signature of the service provider.
The service provider should respond with NotModified status code if the <metadata:IfModifiedSince> element is present and the metadata has not been modified since the time specified in this element.
   <MetaDataGetResponse> Response

The <metadata:MetaDataGetResponse> response contains a provider's metadata information along with a process control directive for requestor.

Schema Definition.

The elements of the response are as follows:
MajorVersion [Required]
   Major version of the response.
MinorVersion [Required]
   Minor version of the response.
Status [Required]
   A status of the request.
IssueInstant [Required]
   The time instant of issue the response.
CacheControl [Optional]
   The cache control directives.
Descriptor [Optional]
   The service provider metadata.
Signature [Optional]
   The response signature.

The schema fragment defining the element and its type is as follows:

```
<element name=“MetaDataGetResponse”
type=“metadata:GetResponseType”/>
<complexType name=“GetResponseType”>
  <sequence>
    <element ref=“libmetadata:Status”/>
    <element name=“IssueInstant” type=“dateTime”/>
    <element  name=“Descriptor”
    type=“lib:ProviderDescriptorType”
            minOccurs=“0”/>
    <element ref=“metadata:CacheControl” minOccurs=“0”/>
    <element ref=“ds:Signature” minOccurs=“0”/>
  </sequence>
  <attribute name=“MajorVersion” type=“integer” use=“required”/>
  <attribute name=“MinorVersion” type=“integer” use=“required”/>
</complexType>
```

Element <Status>.
The <Metadata:Status> Element:
StatusCode [Required]
   The code representing status of corresponding request.
StatusMessage [Any Number]
   A message, which may be returned to an operator.
StatusDetail [Optional]
   Additional information about the error condition.

The schema fragment defining the element and its type is as follows:

```
<element name=“Status” type=“metadata:StatusType”/>
<complexType name=“StatusType”>
  <sequence>
    <element ref=“metadata:StatusCode”/>
    <element ref=“metadata:StatusMessage”  minOccurs=“0”
              maxOccurs=“unbounded”/>
    <element ref=“metadata:StatusDetail” minOccurs=“0”/>
  </sequence>
</complexType>
<element name=“StatusMessage” type=“string”/>
<element name=“StatusDetail” type=“metadata:StatusDetailType”/>
<complexType name=“StatusDetailType”>
  <sequence>
    <any  namespace=“##any”  processContents=“lax”
              minOccurs=“0” maxOccurs=“unbounded”/>
  </sequence>
</complexType>
```

Element <StatusCode>.

The <metadata:StatusCode> element specifies a code representing the status of corresponding request:
Value [Required]
   The status code as defined below.
SubStatusCode [Optional]

An optional subordinate status code that provides more specific information about the error condition.

The following StatusCode values are defined:
Success
   The request succeeded.
NotModified
   The metadata has not been modified since the time specified by the sender.
VersionMismatch
   Receiver could not process the request because of version mismatch.
Receiver
   The request could not be performed due to an error at the receiving end.
Sender
   The request could not be performed due to an error in the sender or in the request.

The schema fragment defining the element and its type is as follows:

```
<element name=“StatusCode” type=“metadata:StatusCodeType”/>
<complexType name=“StatusCodeType”>
  <sequence>
    <element name=“SubStatusCode” type=“integer” minOccurs=“0”/>
  </sequence>
  <attribute name=“Value” type=“metadata:StatusCodeEnumType”
  use=“required”/>
</complexType>
<simpleType name=“StatusCodeEnumType”>
  <restriction base=“QName”>
    <enumeration value=“Success”/>
    <enumeration value=“NotModified”/>
    <enumeration value=“VersionMismatch”/>
    <enumeration value=“Reciever”/>
    <enumeration value=“Sender”/>
  </restriction>
</simpleType>
```

Element <CacheControl>.

The <metadata:CacheControl> element:
MinAge [Optional]
   The minimum caching time (in seconds).
MaxAge [Optional]
   The maximum caching time (in seconds).

The schema fragment defining the element and its type is as follows:

```
<element name=“CacheControl” type=“metadata:CacheControlType”/>
<complexType name=“CacheControlType”>
  <attribute name=“MinAge” type=“integer” use=“optional”/>
  <attribute name=“MaxAge” type=“integer” use=“optional”/>
</complexType>
```

### EXAMPLE

```
<MetaDataGetResponse MajorVersion=“1” MinorVersion=“0”>
  <Status>
    <StatusCode Value=“Success”/>
  </Status>
  <IssueInstant>2002-12-17T09:30:47-05:00</IssueInstant>
  <Descriptor>
    <ProviderID>http://ServiceProvider.com</ProviderID>
    <ProviderSuccinctID>A9FD64E12C</ProviderSuccinctID>
    <ds:KeyInfo>...</ds:KeyInfo>
    <SoapEndpoint>http://ServiceProvider.com/soap</SoapEndpoint>
  <SingleLogoutServiceURL>http://ServiceProvider.com/slo</SingleLogoutServiceURL>
  <SingleLogoutServiceReturnURL>http://ServiceProvider.com/slo_return</SingleLogoutServiceReturnURL>
  <FederationTerminationServiceURL>http://ServiceProvider.com/term</FederationTerminationServiceURL>
  <FederationTerminationServiceReturnURL>http://ServiceProvider.com/term_return</FederationTerminationServiceReturnURL>
  <AssertionConsumerServiceURL>http://ServiceProvider.com/assertion_consumer</AssertionConsumerServiceURL>
  <FederationTerminationNotificationProtocolProfile>http://test.org/profiles/fedterm_{—}
  soap</FederationTerminationNotificationProtocolProfile>
  <SingleLogoutProtocolProfile>http://test.org/profiles/slo_soap</SingleLogoutProtocolProfile>
    <AuthnRequestsSigned>1</AuthnRequestsSigned>
  </Descriptor>
  <CacheControl MinAge=“3600” MaxAge=“36000”/>
  <ds:Signature>...</ds:Signature>
</MetaDataGetResponse>
```

Processing Rules

When a service provider receives an <metadata:MetaDataGetResponse> from another service provider, it processes the request according to the following rules:
<ds:Signature>, if present, is a valid signature of the service provider.
If the value of <metadata:StatusCode> element is NotModified then the current version of the service provider's metadata should be used.
The service provider caches the returned metadata and uses the timestamp returned in the <metadata:IssueInstant> element as the value of the <metadata:IfModifiedSince> element in next metadata request.
If the <metadata:CacheControl> element is present then service provider should not request the metadata again in next minAge seconds and should update the cached metadata after maxAge seconds.
   <MetaDataPostRequest> Request

The service provider issues <metadata:MetaDataPostRequest> request to a metadata service to upload the metadata information.

Schema Definition

The elements of the request are as follows:
MajorVersion [Required]
   Major version of the request.
MinorVersion [Required]
   Minor version of the response.
ProviderID [Required]
   The requestor service provider's URI-based identifier.
Descriptor [Required]
   The service provider metadata.
CacheControl [Optional]
   The cache control directives to be used.
Signature [Optional]
   The request signature.

The schema fragment defining the element and its type is as follows:

```
<element name=“MetaDataPostRequest”
type=“metadata:PostRequestType”/>
<complexType name=“PostRequestType”>
  <sequence>
    <element name=“ProviderID” type=“anyURI”/>
    <element name=“Descriptor” type=“ProviderDescriptorType”/>
    <element ref=“metadata:CacheControl” minOccurs=“0”/>
    <element ref=“ds:Signature” minOccurs=“0”/>
  </sequence>
  <attribute name=“MajorVersion” type=“integer” use=“required”/>
  <attribute name=“MinorVersion” type=“integer” use=“required”/>
</complexType>
```

### EXAMPLE

```
<MetaDataPostRequest MajorVersion=“1” MinorVersion=“0”>
  <ProviderID>http://ServiceProvider.com/id</ProviderID>
  <Descriptor>
    <ProviderID>http://ServiceProvider.com</ProviderID>
    <ProviderSuccinctID>A9FD64E12C</ProviderSuccinctID>
    <ds:KeyInfo>...</ds:KeyInfo>
    <SoapEndpoint>http://ServiceProvider.com/soap</SoapEndpoint>
  <SingleLogoutServiceURL>http://ServiceProvider.com/slo</SingleLogoutServiceURL>
  <SingleLogoutServiceReturnURL>http://ServiceProvider.com/lib/slo_return</SingleLogoutServiceReturnURL>
  <FederationTerminationServiceURL>http://ServiceProvider.com/lib/term</FederationTerminationServiceURL>
  <FederationTerminationServiceReturnURL>http://ServiceProvider.com/term_return</FederationTerminationServiceReturnURL>
  <AssertionConsumerServiceURL>http://ServiceProvider.com/assertion_consumer</AssertionConsumerServiceURL>
  <FederationTerminationNotificationProtocolProfile>http://test.org/profiles/fedterm_{—}
  soap</FederationTerminationNotificationProtocolProfile>
  <SingleLogoutProtocolProfile>http://test.org/profiles/slo_soap</SingleLogoutProtocolProfile>
    <AuthnRequestsSigned>1</AuthnRequestsSigned>
  </Descriptor>
  <CacheControl MinAge=“3600” MaxAge=“36000”/>
  <ds:Signature>...</ds:Signature>
</MetaDataPostRequest>
```

Processing Rules

When a metadata service receives an <metadata:MetaDataPostRequest> from a service provider, it processes the request according to the following rules:
<ds:Signature>, if present, it is the signature of the service provider as specified by the <metadata:ProviderID>.
<metadata:CacheControl>, if present, specifies the cache control directives that should be used in the <metadata:MetaDataGetResponse> when the metadata for this service provider are requested.
   <MetaDataPostResponse> Response

The metadata service issues <metadata:MetaDataPostResponse> response with the results of uploading a service provider's metadata.

Schema Definition

The elements of the response are as follows:
MajorVersion [Required]
   Major version of the response.
MinorVersion [Required]
   Minor version of the response.
Status [Required]
   A status of the request.
IssueInstant [Required]
   The time instant of issue the response.
Signature [Optional]
   The response signature.

The schema fragment defining the element and its type is as follows:

```
<element name=“MetaDataPostResponse”
type=“metadata:PostResponseType”/>
<complexType name=“PostResponseType”>
  <sequence>
    <element ref=“metadata:Status”/>
    <element name=“IssueInstant” type=“dateTime”/>
    <element ref=“ds:Signature” minOccurs=“0”/>
  </sequence>
  <attribute name=“MajorVersion” type=“integer” use=“required”/>
  <attribute name=“MinorVersion” type=“integer” use=“required”/>
</complexType>
```

### EXAMPLE

```
<MetaDataPostResponse MajorVersion=“1” MinorVersion=“0”>
  <Status>
    <StatusCode Value=“Success”/>
  </Status>
  <IssueInstant>2002-12-17T09:30:47-05:00</IssueInstant>
  <ds:Signature>...</ds:Signature>
</MetaDataGetResponse>
```

Processing Rules.

When a service provider receives an <metadata:MetaDataPostResponse> from a metadata service, it processes the request according to the following rules:
<ds:Signature>, if present, it is a valid signature of the service provider.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A process for relating a service provider resource with a fixed identifier that allows resource requestors to consistently access a service provider resource without being affected by changes to the service provider resource, comprising the steps of:
providing request reception means on a central server for receiving a resource information request from a resource requestor for a particular resource;
extracting a service provider identifier from said resource information request;
wherein said identifier is a predetermined identifier;
providing a resource information database resident on said central server that contains cross references from service provider identifiers to service provider resource information;
wherein said database contains resource information for all of the service providers within the central server's area of responsibility;
wherein the database resource information includes, but is not limited to, resource description and resource universal resource locator (URL) address; and
wherein said central server references said database using said extracted service provider identifier and retrieves an associated service provider resource's information from said database.

2. The process of claim 1, wherein said central server's area of responsibility is locality, assignment, or trust based.

3. The process of claim 1, wherein said service provider identifier is a universal resource identifier (URI).

4. The process of claim 1, wherein said central server returns the retrieved service provider resource information to said resource requester.

5. The process of claim 4, wherein said central server verifies said resource information request before returning the retrieved service provider resource information.

6. The process of claim 1, wherein said resource requestor uses the URL from the retrieved service provider resource information to access the resource from the service provider.

7. The process of claim 1, wherein said resource requester uses the retrieved service provider resource information to display the resource description to a user.

8. A process for relating a service provider resource with a fixed identifier that allows resource requestors to consistently access a service provider resource without being affected by changes to the service provider resource, comprising the steps of:
providing request reception means on a service provider site for receiving a resource information request from a resource requester for a particular resource;
extracting a service provider identifier from said resource information request;
wherein said identifier is a predetermined identifier;
providing a resource information database resident on said service provider site that contains cross references from service provider identifiers to information for associated resources of said service provider;
wherein the database resource information includes, but is not limited to, resource description and resource universal resource locator (URL) address; and
wherein said service provider site references said database using said extracted service provider identifier and retrieves an associated resource's information from said database.

9. The process of claim 8, wherein said service provider identifier is a universal resource identifier (URI).

10. The process of claim 8, wherein said service provider site returns the retrieved resource information to said resource requester.

11. The process of claim 10, wherein said service provider site verifies said resource information request before returning the retrieved resource information.

12. The process of claim 8, wherein said resource requestor uses the URL from the retrieved resource information to access the resource from the service provider.

13. The process of claim 8, wherein said resource requestor uses the retrieved resource information to display the resource description to a user.

14. An apparatus for relating a service provider resource with a fixed identifier that allows resource requesters to consistently access a service provider resource without being affected by changes to the service provider resource, comprising:
request reception means on a central server for receiving a resource information request from a resource requestor for a particular resource;
a module for extracting a service provider identifier from said resource information request;
wherein said identifier is a predetermined identifier;
a resource information database resident on said central server that contains cross references from service provider identifiers to service provider resource information;
wherein said database contains resource information for all of the service providers within the central server's area of responsibility;
wherein the database resource information includes, but is not limited to, resource description and resource universal resource locator (URL) address; and
wherein said central server references said database using said extracted service provider identifier and retrieves an associated service provider resource's information from said database.

15. The apparatus of claim 14, wherein said central server's area of responsibility is locality, assignment, or trust based.

16. The apparatus of claim 14, wherein said service provider identifier is a universal resource identifier (URI).

16. The apparatus of claim 14, wherein said central server returns the retrieved service provider resource information to said resource requestor.

17. The apparatus of claim 16, wherein said central server verifies said resource information request before returning the retrieved service provider resource information.

18. The apparatus of claim 14, wherein said resource requestor uses the URL from the retrieved service provider resource information to access the resource from the service provider.

19. The apparatus of claim 14, wherein said resource requester uses the retrieved service provider resource information to display the resource description to a user.

20. An apparatus for relating a service provider resource with a fixed identifier that allows resource requestors to consistently access a service provider resource without being affected by changes to the service provider resource, comprising:
request reception means on a service provider site for receiving a resource information request from a resource requestor for a particular resource;
a module for extracting a service provider identifier from said resource information request;
wherein said identifier is a predetermined identifier;
a resource information database resident on said service provider site that contains cross references from service provider identifiers to information for associated resources of said service provider;
wherein the database resource information includes, but is not limited to, resource description and resource universal resource locator (URL) address; and
wherein said service provider site references said database using said extracted service provider identifier and retrieves an associated resource's information from said database.

21. The apparatus of claim 20, wherein said service provider identifier is a universal resource identifier (URI).

22. The apparatus of claim 20, wherein said service provider site returns the retrieved resource information to said resource requester.

23. The apparatus of claim 23, wherein said service provider site verifies said resource information request before returning the retrieved resource information.

24. The apparatus of claim 20, wherein said resource requestor uses the URL from the retrieved resource information to access the resource from the service provider.

25. The apparatus of claim 20, wherein said resource requester uses the retrieved resource information to display the resource description to a user.
